(19) United States
(12) Patent Application Publication
(10) Pub. No.: US 2011/0261878 A1
(43) Pub. Date: Oct. 27, 2011

(54) BIT RATE CONTROL METHOD AND APPARATUS FOR IMAGE COMPRESSION

(76) Inventors: Keng-Po LU, Xindian City (TW); Jui-Lung Lin, Zhubei City (TW)

(21) Appl. No.: 13/095,508

(22) Filed: Apr. 27, 2011

(30) Foreign Application Priority Data
Apr. 27, 2010 (TW) 99113357

(51) Int. Cl. H04N 7/26; G06K 9/36

(52) U.S. Cl. 375/240.02; 382/239; 375/E07.126

(57) ABSTRACT

Method and apparatus of bit rate control for image compression are provided. The method includes the following steps. With respect to a color channel, image complexity of spatial domain image data of an image is obtained according to the spatial domain image data. A scale factor with respect to the color channel is estimated according to the image complexity and a target bit rate. During image compression of the image, frequency domain image data of the image is quantized according to the estimated scale factor.

This application claims the benefit of Taiwan application Serial No. 99113357, filed Apr. 27, 2010, the subject matter of which is incorporated herein by reference.

### BACKGROUND OF THE INVENTION

1. Field of the Invention

The invention relates in general to an image compression method and apparatus, and more particularly to a method and apparatus of bit rate control for image compression.

2. Description of the Related Art

An image compression coding, by which an original image is compressed and encoded into a data stream, is generally composed of five stages, namely, downsample and color space transform, transform, quantization, coefficient prediction and entropy coding. JPEG format is taken for example. Firstly, the RGB color data of an image is transformed into image data in the form of YCbCr color space. Next, the image data in YCbCr color space are processed according to discrete cosine transform (DCT) and are quantized. Then, the coefficients of the DC item are processed according to difference prediction. Lastly, the coefficients are sequentially scanned according to zig-zag and coded by run-length encoding and are then further encoded according to variable length coding.

Prior to the above quantization process, three quantization tables must be established for each channel of the YCbCr color space. The specification of JPEG provides suggested quantization tables, which are obtained from the statistical analysis of a large amount of pictures. The variation in a quantization table is uniformly controlled by a scale factor. The larger the scale factor, the higher the compression ratio, and vice versa.

For an apparatus being acquiring images, which is subjected to a limited memory space, information regarding the number of photos that can be taken and the available recording time for taking video must be available for the convenience of usage of the apparatus. Such information may be obtained from an estimation with respect to a scale factor in advance. However, the actual results of image compression are often inconsistent with the estimation. Besides, some conventional estimation methods employ DCT computation on the image, and such computation occupies computing resources and is time consuming.

In addition, during the above process of image compression, the determined scale factor cannot be changed before the completion of image compression. For the compressed image data stream or file to comply with the requirement for data size and quality, when it is determined that the current image compression could generate an image file not compliant with the requirement, the conventional method will adjust the scale factor and repeat the above computation. Normally, at least two times of computation involving image compression are needed to obtain an image file complying with the requirement. Thus, the number of clock pulses for computation is increased and more computing resources are consumed.

### SUMMARY OF THE INVENTION

The invention is directed to a method and an apparatus of bit rate control for image compression. A scale factor corresponding to, for example, an expected compression ratio of an image can be estimated according to relationships between image complexity and image compression bit rates for each single channel. By performing image compression according to the estimated scale factor, bit rate control can be performed to result in a compression ratio substantially as expected. In this way, the number of clock pulses for computation and the times for memory access are both reduced.

According to a first aspect, a bit rate control method for image compression is provided. The method includes the following steps. According to spatial domain image data of an image, image complexity of the spatial domain image data with respect to a color channel is obtained. A scale factor with respect to the color channel is estimated according to the image complexity and a target bit rate. During image compression of the image, the frequency domain image data of the image is quantized according to the estimated scale factor with respect to the color channel.

According to a second aspect, a bit rate control apparatus for image compression is provided. The apparatus includes a scale factor estimation module and an image compression unit. The scale factor estimation module, according to spatial domain image data of an image, obtains image complexity of the spatial domain image data with respect to a color channel, and estimates a scale factor with respect to the color channel according to the image complexity and a target bit rate. During image compression of the image, the image compression unit quantizes frequency domain image data of the image according to the estimated scale factor with respect to the color channel so as to generate image compression data.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a flowchart of a method with bit rate control method for image compression according to an embodiment of the invention.

FIG. 2 shows an example of the relationship between the image complexity of the Y channel and the number of bytes of results of image compression.

FIG. 3 shows an embodiment of a polynomial model of a channel.

FIG. 4 shows an estimation of scale factor by interpolation.

FIG. 5 shows a block diagram of a bit rate control apparatus for image compression according to an embodiment of the invention.

FIG. 6 shows a scale factor estimation module according to an embodiment of the invention.

### DETAILED DESCRIPTION

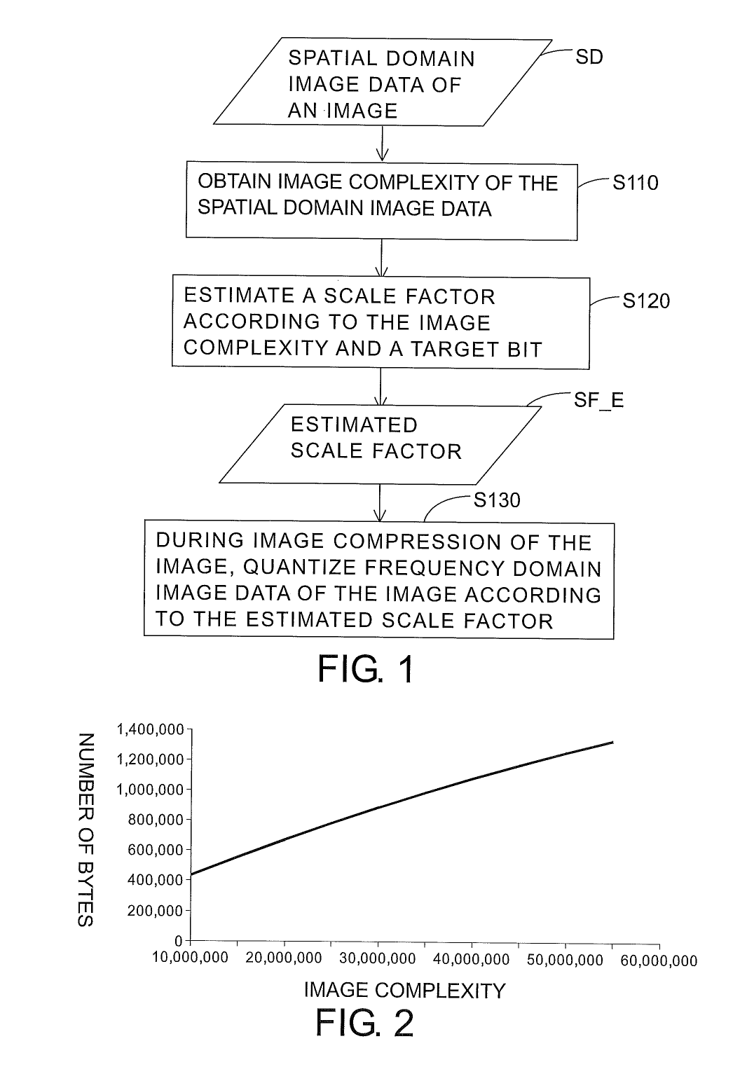

Referring to FIG. 1, a flowchart of a bit rate control method for image compression according to an embodiment of the invention is shown. As indicated in FIG. 1, SD denotes spatial domain image data of an image. In step S110, image complexity of the spatial domain image data SD is obtained. In step S120, a scale factor (denoted by SF_E) with respect to a color channel (or referred to as channel) is estimated according to the image complexity obtained in step S110 and a target bit rate. In step S130, during image compression, frequency domain image data of the image is quantized according to the estimated scale factor SF_E of each channel.

The bit rate control method of the embodiment can be used in an image compression method (for example, the data compression method such as JPEG or MPEG or the like) in which the spatial domain image data needs to be transformed into frequency domain image data. The method of FIG. 1 is exemplified by JPEG compression, but the present embodiment is not limited thereto.

If the above embodiment is exemplified by JPEG compression, then the spatial domain image data SD is pixel data or a data flow obtained by sampling and performing color space transform on the original image. In order to estimate the scale factor, the calculation of complexity can be performed on spatial domain image data SD having the same size as the original image or having been scaled. For example, the computation of complexity can be based on the spatial domain image data SD downsized by 50% or the thumbnail so as to reduce the computation required for estimating the scale factor.

In step S110, the measurement of image complexity is based on the image noise level, such as the measurement based on the edge and texture of an image, or the image pixel difference between several consecutive scenes, or scene change of a video. The image noise level can be represented by a numerical value obtained by a particular measurement as image complexity. For example, the numerical representation of image complexity can be realized by the output (or the numeric values of picture output) of the spatial domain image data SD processed by the edge or the texture detection filter, which can be realized by a circuit or software.

In an example, the noise level per pixel of the spatial domain image data SD can be computed, and the noise level per pixel can be obtained from the weighted average of the noise levels and used for denoting the image complexity. For example, an M×N (such as 3×3 or 5×5) edge detection filter is used for computing the edges and noise weighting of an image. The noise level of a pixel p can be obtained by processing the pixel p and its surrounding M×N−1 pixels of an image-processed image with the M×N edge detection filter. The noise level per pixel for the whole image can be determined by the weighted summation of the noise levels of all pixels divided by the total number of pixels of the image. In other examples, various edge or texture filters in spatial domain, such as Laplacian filter, Roberts filter, Sobel filter, or Prewitt filter, can be used for computing the complexity like the above examples. In addition, the unit of complexity can be changed according to actual needs of application. For example, the noise level per million pixels can be used to reduce the complicated computation of division. Thus, the numeric representation of complexity is not limited to the above exemplifications.

In other examples, the image pixel difference between several consecutive scenes or the scene change of a video can be used for measuring the complexity, and the numeric values of complexity can be represented by the statistics or the weighted average of the above measurement. Thus, the above examples of the computation of image complexity of step S110 are not for limiting the implementation of step S110, and any other measurements capable of reflecting image complexity in spatial domain can be used for implementing step S110.

In step S120, since there is a relationship among scale factor, bit rate, and image complexity, the scale factor can be estimated according to the image complexity obtained from step S110 and a target bit rate, wherein the relationship among the above three parameters can be represented by a polynomial model. The target bit rate corresponds to a desired compression ratio (such as 2:1, 4:1 or 8:1) when taking photo or video with an image acquiring apparatus, or to the selection of image quality, such as high quality, mediocre quality, or low quality. In addition, the target bit rate corresponds to the desired size of the target file, or the desired number of photos to be taken or the desired recording time with respect to the memory space currently available.

The polynomial model can be established in advance, for example. The statistics of experimental data shows that for the same scale factor, there is high correlation between image complexity (such as the noise level) of a single channel and image compression bit rates in spatial domain. For example, more than 100 sheets of sampled image (such as 1280×960) with different contents taken with the same image acquiring apparatus are analyzed to obtain the relationship between the image complexity of each channel with respect to the same scale factor and number of bytes of image compression results. The measurement of image complexity is based on the edge complexity. The sampled image is downsized by 50% and is further processed by the edge detection filter. The complexity of the sampled image is obtained by weighting average of the processed results outputted from the edge detection filter. The statistical analysis shows there is high correlation between the image complexity (denoted by x) of each single channel and the number of bytes (denoted by y) of image compression results. As indicated in FIG. 2, with respect to a Y channel, the results are represented by a curve of the second degree as: y=−10⁻¹⁰x²+0.0264x+184198, wherein the multiple correlation coefficient is expressed as: R²=0.9844. In addition, with respect to a U channel, when the image complexity ranges between 7×10⁶ to 4.1×10⁷, the number of bytes of image compression results is expressed as: y=−2x10⁻¹¹x²+0.0124x+13999, wherein the multiple correlation coefficient is expressed as: R²=0.9978. Lastly, with respect to a V channel, when the image complexity ranges between 6×10⁶ to 3.2×10⁷, the number of bytes of image compression results is expressed as: y=3×10⁻¹¹x²+0.0104x+33433, wherein the multiple correlation coefficient is expressed as: R²=0.994.

Since the above correlations have similar properties in the three channels of the YCbCr color space, individal mathematical model with respect to the correlation property can be developed for each channel. For example, with respect to a scale factor (e.g., denoted by SF), the relationship (denoted by f_SF) between image complexity and image compression bit rate for each channel can be represented by a linear or a polynomial model. The estimate of the scale factor most approaching the target bit rate can be obtained from the relationship (f_SF₁, f_SF₂, . . . , f_SFₙ) between the image complexity corresponding to a plurality of different scale factors (SF₁, SF₂ . . . SFₙ) and resulted bit rates. Further, the data of the image complexity corresponding to different scale factors and the data of the resulted bit rates are affected, during experiment, by the source of the samples images due to the properties of the image acquiring element, which generates the sample image, the preceding processing of the spatial domain image data, or the image processing parameters that are taken, such as ISO, noise reduction, picture size, and exposure time. The statistics of experimental data shows that for the same scale factor, there is high correlation between image complexity of a single channel and image compression bit rate in spatial domain. Thus, with respect to an image acquiring apparatus, the relationship between every two of the three parameters can be represented with a polynomial model so that the scale factor can be estimated and the expected compression ratio can be achieved. For example, for the images with different resolutions, similar rate-distortion curves can be obtained, and the accuracy of the estimated scale factor can be higher than 90%.

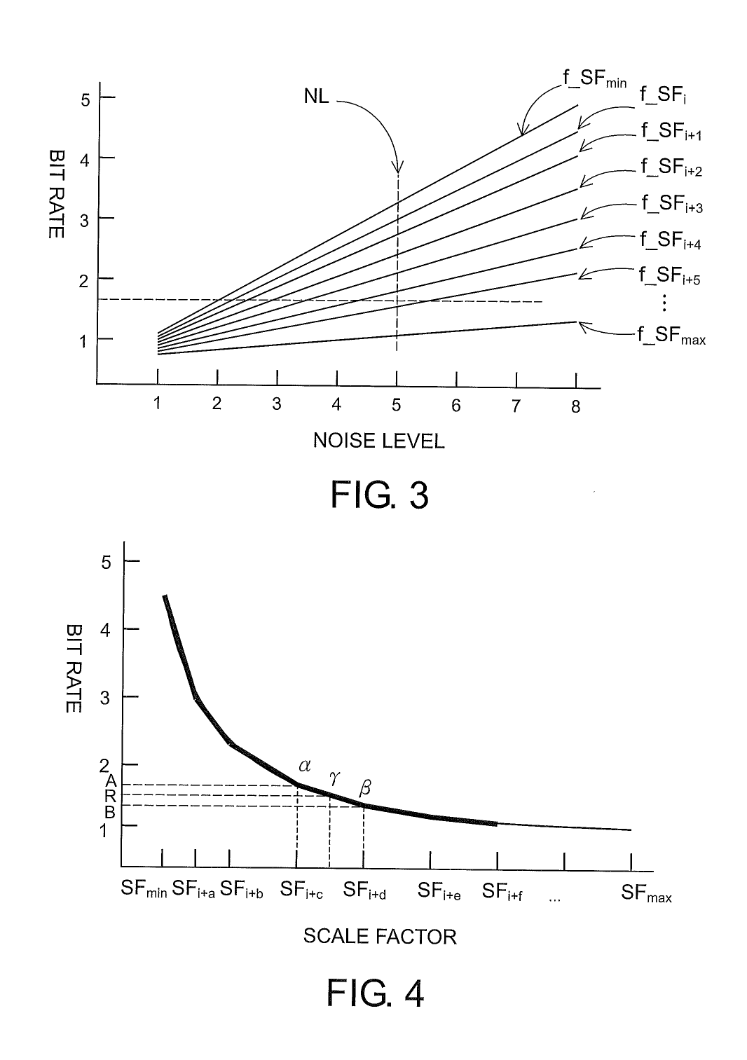

FIG. 3 illustrates that with respect to different scale factors (e.g., scale factors arranged in an ascending order: SFₘᵢₙ . . . SFᵢ, SFᵢ₊₁, SFᵢ₊₂, SFᵢ₊₃, SFᵢ₊₄, SFᵢ₊₅ . . . SFₘₐₓ) of a single channel (such as the Y channel), respective relationships (f_SFₘᵢₙ . . . f_SFᵢ, f_SFᵢ₊₁, f_SFᵢ₊₂, f_SFᵢ₊₃, f_SFᵢ₊₄, f_SFᵢ₊₅ . . . f_SFₘₐₓ) exist between image noise levels and image compression bit rates. For example, a polynomial model database can be ultilized to represent these relationships for the three YCbCr channels. In this example, the relationships are exemplified by linear relationships and the polynomial model database, for example, includes coefficients of polynomials representing the relationships for each channel, and can be stored in a memory or represented with data structures of a program. In step S120, according to the Y channel image noise level obtained in step S110 and the desired Y channel image compression bit rate (that is, the target bit rate), a number of polynomial models corresponding to quantization table scale factors for the Y channel can be found from the database so as to obtain a linear relationship most approaching the desired image compression bit rate for the Y channel. As indicated in FIG. 3, a straight line NL is shown corresponding to image noise level being 5 per pixel for the Y channel, the scale factor most approaching the desired image compression bit rate being 1.7 bits per pixel for the Y channel falls between at least two known scale factors SFᵢ₊₄ and SFᵢ₊₅. An estimated scale factor SF_E can be determined from the relationships f_SFᵢ₊₄ and f_SFᵢ₊₅ by interpolation method. Likewise, the quantization table scale factors for the Cb channel and the Cr channel can be obtained in the same manner.

FIG. 4 shows an estimation of scale factor by interpolation. Based on the image noise level for the Y channel, it can be found in the polynomial model database that with respect to the Y channel, the image compression bit rates A and B respectively most approach the upper and lower limits of the image compression target bit rate R. As indicated in FIG. 4, the slope can be derived from the quantization table scale factor α and β corresponding to the image compression bit rates A and B for the Y channel, and the quantization table scale factor γ corresponding to the target bit rate of image compression R for the Y channel can be obtained by interpolation as follows:

γ=α+(R-B)/(A-B)*(α-β).

Likewise, the quantization table scale factors for the Cb channel and the Cr channel can be obtained in the same manner.

FIG. 3 illustrates a polynomial model database for a channel in a graphical manner, wherein there is an interval between any two adjacent ones of the scale factors corresponding to the relationships (polynomials). The intervals, for example, can be a fixed constant or non-fixed constants (that is, the intervals can be different). In another embodiment, the intervals for any two adjacent scale factors of the polynomial model database can be set in a different manner so as to speed a search for a corresponding target scale factor. As indicated in FIG. 3, the intervals a to f of different scale factors SFₘᵢₙ, SFᵢ₊ₐ, SF_{i+b}, SF_{i+c}, SF_{i+d}, SFᵢ₊ₑ, SF_{i+f} . . . SFₘₐₓ for a single channel can be a fixed constant or non-fixed constants.

In steps S110 and S112, the image complexities of the color space channels (such as channels Y, Cb and Cr) of the spatial domain image data SD can be respectively calculated so as to estimate respective scale factors. In addition, in response to the needs in application or the user's setting (for example, the original image is a black/white image), image complexity can be calculated and scale factor can be estimated with respect to luminance or chrominance only.

In the above embodiment, an initialized setting of the scale factor enables image encoding to approach the expected compression ratio after image encoding. The embodiment can be applied to situations where a fixed-sized buffer is employed so that it is needed to pre-determine the remaining available buffer space, the remaining capacity of image taking or the recording time. The method can be used in both one-pass bit rate control and multi-pass bit rate control.

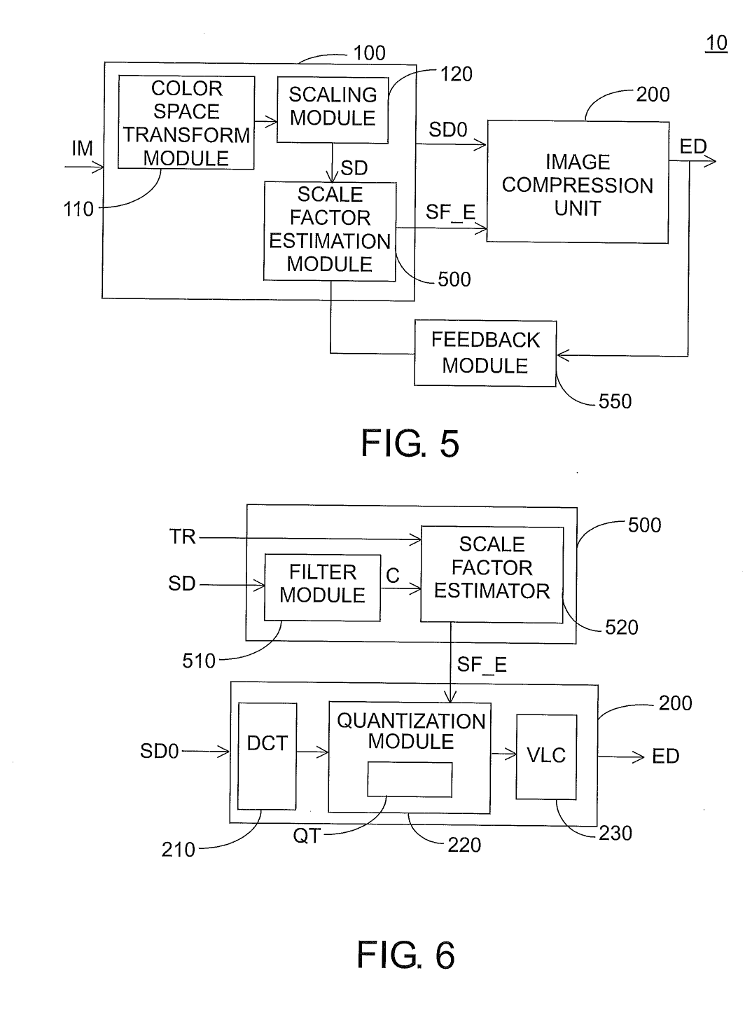

Referring to FIG. 5, a block diagram of a bit rate control apparatus 10 for image compression according to an embodiment of the invention is shown. In the embodiment illustrated in FIG. 5, bit rate control for JPEG is performed on a YUV444 image or data stream according to the bit rate control method used in the above embodiment.

The bit rate control apparatus 10 for image compression includes an image quality adjustment unit 100 and an image compression unit 200. The image quality adjustment unit 100 performs preceding image processing of image compression to provide the spatial domain image data SD0 of an image IM and an estimated scale factor SF_E for the image compression unit 200 to generate a compressed image data ED. A YCbCr data stream (that is, the spatial domain image data SD0 of the image IM) is obtained from the original image IM which is sampled by the image quality adjustment unit 100 and transformed by the color space transform module 110. To reduce the amount of computation for the image quality adjustment unit 100, the YCbCr data stream is processed by a scaling module 120 in a manner that the height and the width of the original image are both down-sized by 50%. In other words, the data amount of the spatial domain image data SD is reduced to be ¼ of the original image. The image quality adjustment unit 100 uses a scale factor estimation module 500 to calculate the image complexity of the data streams of the YCbCr channels of the spatial domain image data SD. The scale factor estimation module 500, according to the obtained image complexity and a target bit rate, estimates a scale factor with respect to a color channel (denoted by SF_E) from the relationship among the scale factor, the image compression bit rates, the image complexity as disclosed in the above embodiment (represented in a polynomial database) so as to obtain the quantization table scale factors of the YCbCr channels.

As indicated in FIG. 6, the image compression unit 200 configures a quantization table QT according to an estimated scale factor SF_E which is most approaching the image compression target bit rate so as to perform JPEG coding and generate compressed image data ED. During image compression, the quantization module 220 quantizes the frequency domain image data generated by the discrete cosine transform (DCT) module 210 according to the estimated scale factor SF_E for each channel, and then the variable length coding (VLC) module 230 is used for encoding. In general, for the elements of the quantization table QT, such as JPEG, each channel respectively corresponds to an 8×8 numeric matrix. For example, the independent JPEG group (IJG) provides a suggested luminance quantization table and chrominance quantization table, and various digital cameras or image processing software have respective luminance quantization tables and chrominance quantization tables. Thus, the values of the quantization table can be scaled according to the scale factor SF_E for each channel so as to obtain a required quantization table QT.

Anyone who is skilled in the technology of the invention will understand that the above apparatus can be used for implementing each embodiment using the above method, and can further be extended to the application in the YUV420 and the YUV422 format.

In addition, a feedback module 550 can further be added to the embodiment illustrated in FIG. 5, so that the bit rate control using the scale factor estimation module further have self-control or self-adjustment function.

The feedback module 550 can check whether the image compression bit rate approaches the target bit rate. If the image compression bit rate approaches the target bit rate within an expected range, then one-pass bit rate control is performed; otherwise, a multi-pass bit rate control method is used to determine the scale factor for next JPEG coding. The estimated scale factor, which already approaches the target scale factor of image compression, can be used as a reference for the next JPEG coding. Such application of the estimated scale factor in the conventional multi-pass bit rate control method would result in reduced computation complexity.

The feedback module 550 can record the image compression bit rates and the target bit rate for statistical calculation. For example, by linear or multivariate regression analysis, with respect to the relationship among scale factor, image compression bit rates, and image complexity of the above embodiments or other image parameters, the contents of the polynomial model database such as polynomial coefficients can be adjusted or changed, or a new polynomial model can be established to meet the properties of the actually used system, such as the image acquiring apparatus, or meet the user's special requirements for shooting a particular scene. The feedback module 550 can be realized by a digital circuit and a memory buffer. In other examples, the feedback module 550 can be integrated into the image quality adjustment unit 100 or the scale factor estimation module 500 or realized by way of programming.

FIG. 6 shows another embodiment, which differs from the embodiment of FIG. 5 in that the scale factor estimation module 500 is an independent module including a filter module 510 and a scale factor estimator 520. The filter module 510 calculates the spatial domain image data SD of an image IM to output corresponding image complexity C. With respect to each channel, the scale factor estimator 520, according to the obtained image complexity C and a target bit rate TR, estimates a scale factor SF_E for each channel by using the relationship among scale factor, image compression bit rate, and image complexity in the above embodiment (such as an established polynomial database) so as to obtain the scale factors of the quantization tables for the YCbCr channels. The estimation of scale factor is exemplified , as illustrated in FIG. 3 or FIG. 4, by finding an upper limit and a lower limit of scale factors corresponding to two polynomials most approaching the target bit rate from the polynomial database, and then obtaining the estimated scale factor with interpolation method.

In practical application, the bit rate control apparatus for image compression 10 can be realized by a single chip of an image processor or a multi-media processor. Furthermore, the image quality adjustment unit 100 can be realized by an image processing circuit or chip of a processor or digital signal processor. The scale factor estimation module 500 can be realized as disclosed in the above embodiments, by way of hardware circuit, programming the image processing circuit, or using the software and hardware approach of an image processing circuit based on a processor.

Besides, the implementation of the bit rate control apparatus for image compression 10 and the scale factor estimation module 500 is not limited to the exemplifications of the above embodiments. Any circuits which estimates a quantization table scale factor for a channel (or a parameter corresponding to the quantization table of scale factor) according to the relationship among scale factor, image compression bit rate, and image complexity as disclosed in the above embodiments are regarded as embodiments of the invention.

For example, in an embodiment, the scale factor estimation module 500 can be implemented to receive a target bit rate TR and edge detection results generated by an image processor in the preceding image processing process so as to estimate a scale factor.

For example, during the process of video coding (such as the MPEG type including MPEG, MPEG-2), an I-frame is equivalent to an independent image, which is also compressed according to the JPEG format. Thus, the above embodiments can be used in the bit rate control circuit and method for video coding. The above embodiments can be employed in the bit rate control circuit and method for video coding for other image or video coding formats based on frequency domain image transform (such as DCT) and quantization, such as motion-JPEG, and even 3D image formats, such as multi-picture object (MPO) and 3D-AVI.

A method and an apparatus of bit rate control for image compression are disclosed in the above embodiments. During image compression, an estimated parameter of a quantization table such as a scale factor can be used for controlling the bit rate so as to obtain a compression ratio complying with an expected ratio. Through statistical analysis, the accuracy is larger than 90%. In comparison to the conventional method which requires a large number of repetition or involves estimation of frequency domain image data, the above embodiments can result in reduced number of clock pulses for computation and reduced number of memory access, and accurately provides the user with the information regarding the available time or memory space of the buffer region of the image acquiring apparatus.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A bit rate control method for image compression, comprising:
according to spatial domain image data of an image, obtaining image complexity of the spatial domain image data with respect to a color channel;
estimating a scale factor with respect to the color channel according to the image complexity and a target bit rate; and
during image compression of the image, quantizing frequency domain image data of the image according to the estimated scale factor with respect to the color channel.

2. The bit rate control method according to claim 1, wherein the spatial domain image data is a spatial domain image data stream obtained by performing color space transform and scaling process on original image data of the image.

3. The bit rate control method according to claim 1, wherein with respect to the color channel, the image complexity of the spatial domain image data of the image is a noise level based on edges or texture of the spatial domain image data.

4. The bit rate control method according to claim 1, wherein with respect to the color channel, the image complexity of the spatial domain image data of the image is measured based on pixel difference between the image and at least one scene of a video including the image, or based on scene change of a video including the image.

5. The bit rate control method according to claim 1, wherein in the step of estimating the scale factor, with respect to the color channel, the scale factor is estimated based on relationships between image complexity and image compression bit rates corresponding to a plurality of scale factors for the color channel.

6. A bit rate control apparatus for image compression, comprising:
a scale factor estimation module, according to the spatial domain image data of an image, for obtaining image complexity of the spatial domain image data with respect to a color channel, and for estimating a scale factor with respect to the color channel according to the image complexity and a target bit rate; and
an image compression unit, during image compression of the image, for quantizing frequency domain image data of the image according to the estimated scale factor with respect to the color channel so as to generate image compression data.

7. The bit rate control apparatus according to claim 6, wherein the spatial domain image data is a spatial domain image data stream obtained by performing color space transform and scaling process on original image data of the image.

8. The bit rate control apparatus according to claim 6, wherein with respect to the color channel, the image complexity of the spatial domain image data of the image is a noise level based on edges or texture of the spatial domain image data.

9. The bit rate control apparatus according to claim 6, wherein with respect to the color channel, the image complexity of the spatial domain image data of the image is measured based on pixel difference between the image and at least one scene of a video including the image or scene change of a video including the image.

10. The bit rate control apparatus according to claim 6, wherein, with respect to the color channel, the scale factor estimation module estimates the scale factor according to relationships between image complexity and image compression bit rates corresponding to a plurality of scale factors for the color channel.

11. The bit rate control apparatus according to claim 10, wherein the scale factor estimation module comprises:
a filter module for obtaining the image complexity of the spatial domain image data with respect to the color channel according to the spatial domain image data; and
a scale factor estimator for estimating the scale factor with respect to the color channel according to the image complexity and the target bit rate.

12. The bit rate control apparatus according to claim 11, further comprising:
a feedback module for controlling the scale factor estimation module according to the image compression bit rates and the target bit rate.
